(19) United States
(12) Patent Application Publication
(10) Pub. No.: US 2025/0141145 A1
(43) Pub. Date: May 1, 2025

(54) CONNECTOR

(71) Applicant: SUMITOMO WIRING SYSTEMS, LTD., Mie (JP)

(72) Inventor: Masafumi SHIMASAKI, Mie (JP)

(21) Appl. No.: 18/837,892

(22) PCT Filed: Jan. 27, 2023
(86) PCT No.: PCT/JP2023/002735

§ 371 Date: Aug. 13, 2024

(30) Foreign Application Priority Data
Feb. 15, 2022 (JP) 2022-021083

(51) Int. Cl. H01R 13/424

(52) U.S. Cl. CPC H01R 13/424

(57) ABSTRACT

A connector includes a female terminal fitting to be inserted into a terminal accommodation chamber from behind a housing body, and a terminal holding member to be attached to cover a front surface of the housing body and configured to hold the female terminal fitting in the terminal accommodation chamber to prevent any further forward movement. The housing body is formed with a locking lance to be resiliently deformed due to interference with the female terminal fitting in an insertion process of the female terminal fitting and configured to retain the female terminal fitting inserted into the terminal accommodation chamber. The terminal holding member is formed with a jig insertion hole into which a jig is inserted, a tab insertion hole into which a tab of a male terminal fitting is inserted and a guiding surface for guiding the tab into the tab insertion hole.

### TECHNICAL FIELD

The present disclosure relates to a connector.

### BACKGROUND

Patent Document 1 discloses a connector in which a terminal mounted in a connector housing is prevented from moving any further forward by a front holder mounted on a front end part of the connector housing. The terminal mounted in the connector housing is locked and retained by a resiliently deformable locking lance. The front holder is formed with a mating terminal insertion hole and a jig rod insertion hole. An opening edge part of the mating terminal insertion hole in the front surface of the front holder is formed with a tapered guiding surface for guiding the mating terminal into the hole. In pulling out the terminal fitting from the connector housing, the locking lance is resiliently deformed to be disengaged from the terminal by a jig inserted into the jig insertion hole.

### PRIOR ART DOCUMENT

### Patent Document

Patent Document 1: JP 2001-297816 A

### SUMMARY OF THE INVENTION

### Problems to be Solved

In the above connector, the mating terminal insertion hole and the jig rod insertion hole are arranged side by side in the same direction as a resilient deformation direction of the locking lance. In the case of reducing the size of this connector in the resilient deformation direction of the locking lance, the jig insertion hole may be arranged near the mating terminal insertion hole and a part of an opening region of the jig insertion hole may be arranged to overlap the guiding surface. However, if a part of the guiding surface is cut by the jig insertion hole, the mating terminal may be erroneously inserted into the jig insertion hole. As a countermeasure against this, it is considered to narrow the opening region of the jig insertion hole so that the jig insertion hole does not overlap the guiding surface. However, if the jig insertion hole is narrowed, the jig has to be thinned. Thus, in view of the strength of the jig, there is a limit in reducing the opening region of the jig insertion hole. Therefore, a size reduction cannot be achieved while the erroneous insertion of the mating terminal is prevented.

A connector of the present disclosure was completed on the basis of the above situation and aims to achieve a size reduction while preventing erroneous insertion.

### Means to Solve the Problem

The present disclosure is directed to a connector with a housing body including a terminal accommodation chamber, a female terminal fitting to be inserted into the terminal accommodation chamber from behind the housing body, and a terminal holding member to be attached to the housing body to cover a front surface of the housing body, the terminal holding member holding the female terminal fitting in the terminal accommodation chamber to prevent any further forward movement, the housing body being formed with a locking lance to be resiliently deformed due to interference with the female terminal fitting in an insertion process of the female terminal fitting, the locking lance retaining the female terminal fitting inserted into the terminal accommodation chamber, the terminal holding member being formed with a jig insertion hole, a jig for disengaging the locking lance from the female terminal fitting being inserted into the jig insertion hole, a tab insertion hole, a tab of a male terminal fitting being inserted into the tab insertion hole from front of the terminal holding member, and a guiding surface for guiding the tab into the tab insertion hole, and the tab insertion hole and the jig insertion hole being arranged side by side in a width direction intersecting a resilient deformation direction of the locking lance.

### Effect of the Invention

According to the present disclosure, a size reduction can be achieved while erroneous insertion is prevented.

### BRIEF DESCRIPTION OF THE DRAWINGS

FIG. 1 is a perspective view showing a state where a terminal holding member is mounted at a complete locking position in a connector of one embodiment.

FIG. 2 is a perspective view showing a state where the terminal holding member is mounted at a temporary locking position.

FIG. 3 is a perspective view showing a state where a housing is divided into a housing body and the terminal holding member.

FIG. 4 is an enlarged perspective view partly in section showing the shape of a locking lance.

FIG. 5 is a side view in section cut in tab insertion holes showing a state where the terminal holding member is at the temporary locking position.

FIG. 6 is a side view in section cut in a jig insertion hole showing the state where the terminal holding member is at the temporary locking position.

FIG. 7 is a side view in section cut in the jig insertion hole showing a state where the terminal holding member is at the temporary locking position and a locking lance is resiliently deformed by a jig.

FIG. 8 is a side view in section cut in the tab insertion hole showing the state where the terminal holding member is at the complete locking position.

FIG. 9 is a side view in section cut in the jig insertion hole showing the state where the terminal holding member is at the complete locking position.

FIG. 10 is a plan view in section.

FIG. 11 is a plan view in section showing a state where the jig is inserted in the jig insertion hole.

FIG. 12 is a front view of the terminal holding member.

FIG. 13 is a partial enlarged plan view in section of the terminal holding member.

FIG. 14 is a perspective view of the jig.

FIG. 15 is a plan view of the jig.

FIG. 16 is a front view of the jig.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing body including a terminal accommodation chamber, a female terminal fitting to be inserted into the terminal accommodation chamber from behind the housing body, and a terminal holding member to be attached to the housing body to cover a front surface of the housing body, the terminal holding member holding the female terminal fitting in the terminal accommodation chamber to prevent any further forward movement, the housing body being formed with a locking lance to be resiliently deformed due to interference with the female terminal fitting in an insertion process of the female terminal fitting, the locking lance retaining the female terminal fitting inserted into the terminal accommodation chamber, the terminal holding member being formed with a jig insertion hole, a jig for disengaging the locking lance from the female terminal fitting being inserted into the jig insertion hole, a tab insertion hole, a tab of a male terminal fitting being inserted into the tab insertion hole from front of the terminal holding member, and a guiding surface for guiding the tab into the tab insertion hole, and the tab insertion hole and the jig insertion hole being arranged side by side in a width direction intersecting a resilient deformation direction of the locking lance. According to the configuration of the present disclosure, a size reduction can be achieved in the resilient deformation direction of the locking lance even if the jig insertion hole is not arranged to overlap the guiding surface of the tab insertion hole. Thus, the size reduction in the resilient deformation direction of the locking lance can be achieved while the erroneous insertion of the tab into the jig insertion holes is prevented.

(2) Preferably, the terminal holding member includes a retaining portion for preventing a rearward movement of the female terminal fitting in the terminal accommodation chamber. According to this configuration, the number of components can be reduced as compared to the case where a dedicated member for retaining the female terminal fitting is provided separately from the terminal holding member.

(3) Preferably, the locking lance is formed with a jig contact portion to be contacted by the jig, the terminal holding member is movable between a temporary locking position where insertion of the female terminal fitting is allowed and a complete locking position where the female terminal fitting is retained, and the jig insertion hole is arranged at a position separated from the jig contact portion in a front view of the terminal holding member when the terminal holding member is at the complete locking position. According to this configuration, with the terminal holding member located at the complete locking position, erroneous deflection of the locking lance can be prevented even if the jig is inserted into the jig insertion hole.

(4) Preferably, the locking lance is formed with a jig contact portion to be contacted by the jig, and the jig contact portion is arranged in a region outward of an outer side surface of the female terminal fitting in the width direction. According to this configuration, the interference of the jig and the female terminal fitting can be prevented when the jig contacts the jig contact portion.

(5) Preferably, the locking lance is formed with a jig contact portion to be contacted by the jig, the jig insertion hole is formed with a guide surface, and the guide surface is inclined to an insertion direction of the tab into the tab insertion hole in a plan view of the terminal holding member when viewed in the same direction as the resilient deformation direction of the locking lance. According to this configuration, the jig can be obliquely brought into contact with the jig contact portion by inserting the jig along the guide surface into the jig insertion hole. Therefore, even if the jig and the jig contact portion have a narrow shape, the jig can be reliably brought into contact with the jig contact portion.

(6) Preferably, in (5), the guide surface is formed on an inner side surface distant from the tab insertion hole, out of a pair of inner side surfaces facing each other in the width direction in the jig insertion hole. According to this configuration, it is possible to ensure a large thickness of a separation wall between the jig insertion hole for one terminal accommodation chamber, out of the terminal accommodation chambers adjacent in the width direction, and the tab insertion hole for the other terminal accommodation chamber.

(7) Preferably, in (5) or (6), the jig insertion hole is formed with a straight surface facing the guide surface in the width direction and parallel to the insertion direction of the tab into the tab insertion hole. According to this configuration, the jig insertion hole can be molded by a mold, which is opened in parallel to the insertion direction of the tab into the tab insertion hole.

(8) Preferably, in (5) to (7), a front end of the guide surface is located outward of an outer side edge of the locking lance in the width direction. According to this configuration, since a large angle of inclination of the guide surface to the insertion direction of the tab into the tab insertion hole is ensured, the jig can be more reliably brought into contact with the jig contact portion.

(9) Preferably, an opening dimension in the width direction at a rear end of the jig insertion hole is smaller than that at a front end of the jig insertion hole. According to this configuration, the jig can be prevented from moving any further forward by a difference between the opening dimensions in the width direction at the front end and the rear end of the jig insertion hole.

### DETAILS OF EMBODIMENT OF PRESENT DISCLOSURE

### Embodiment

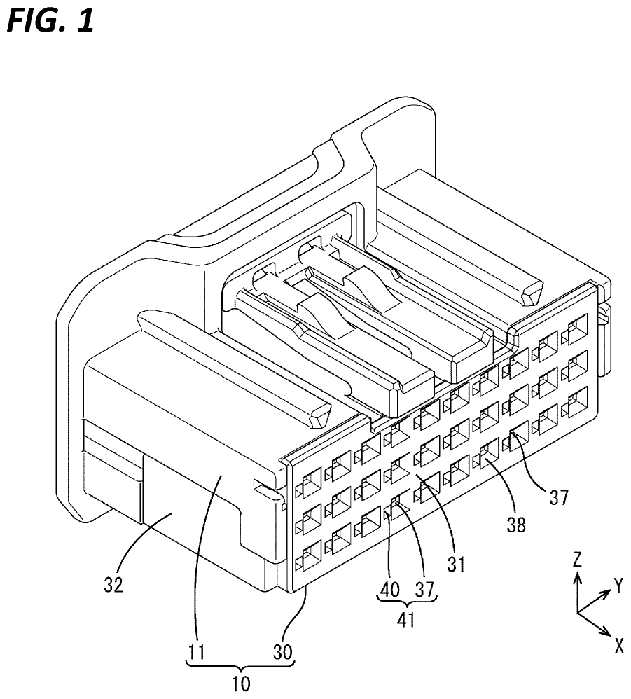

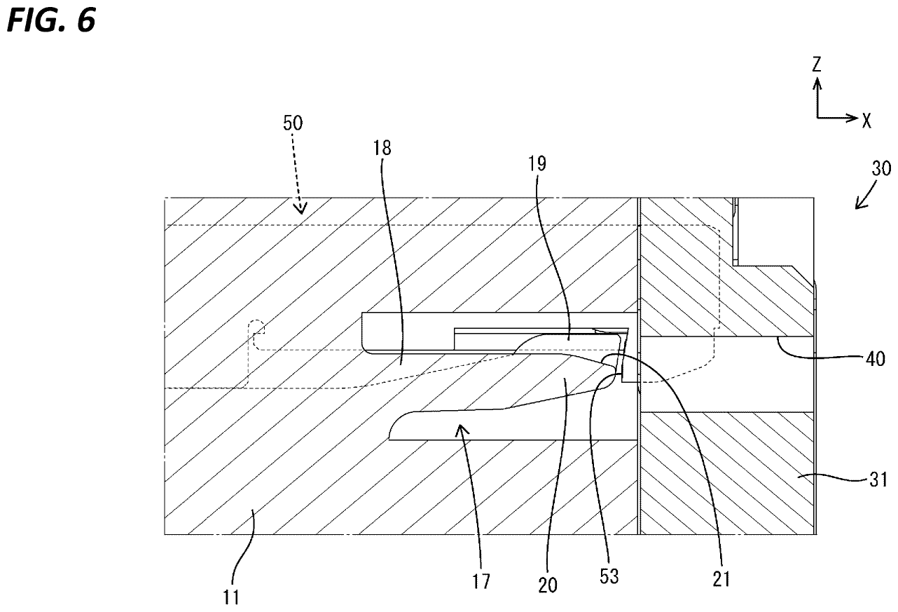

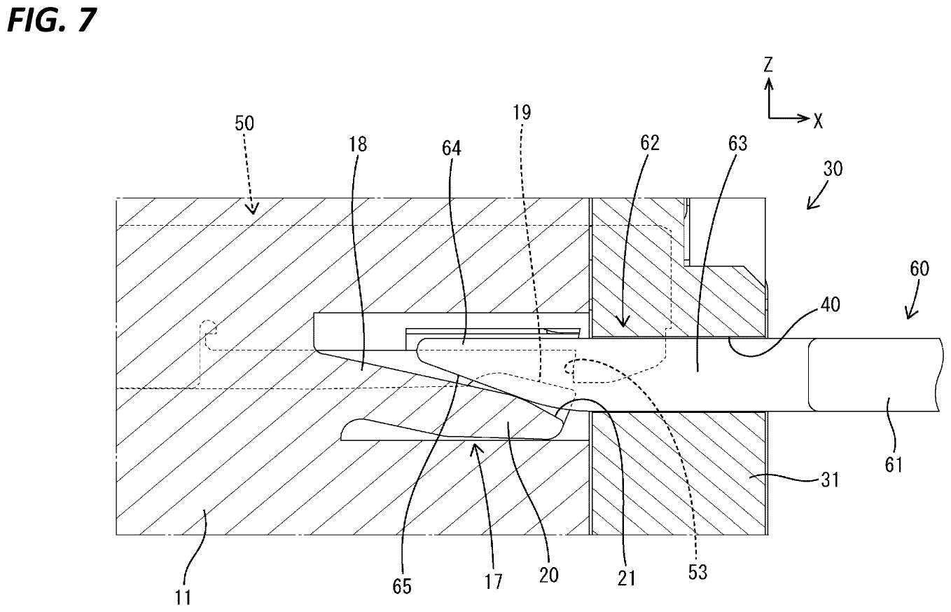

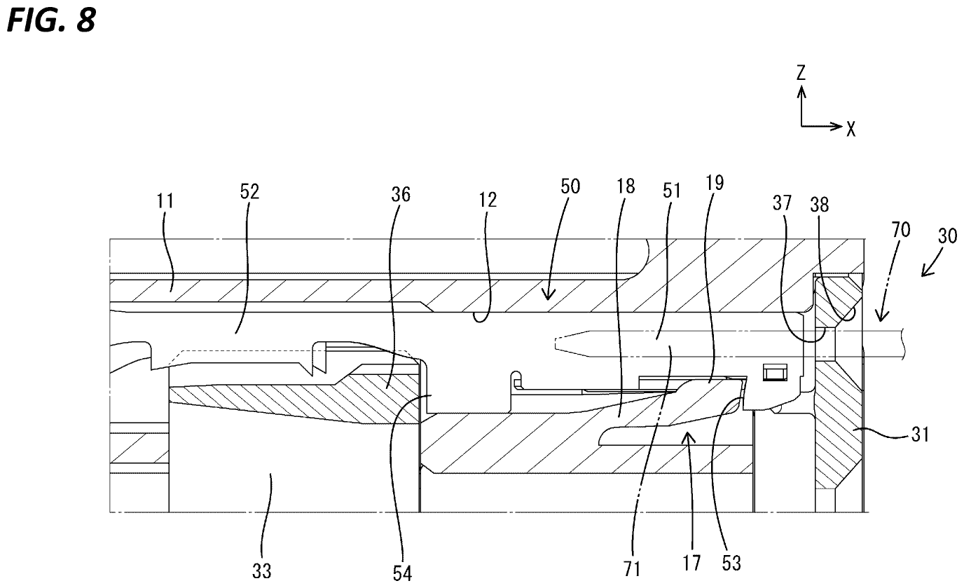

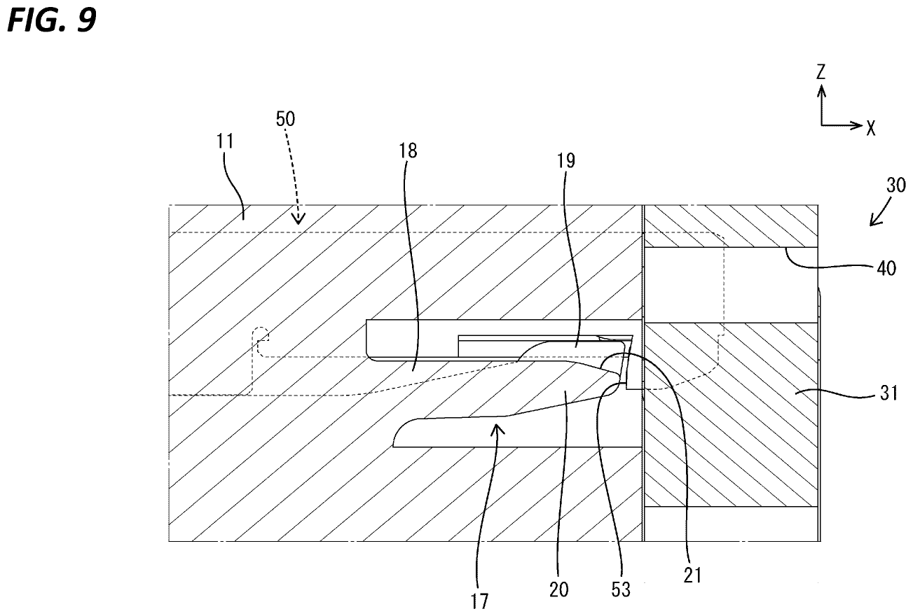

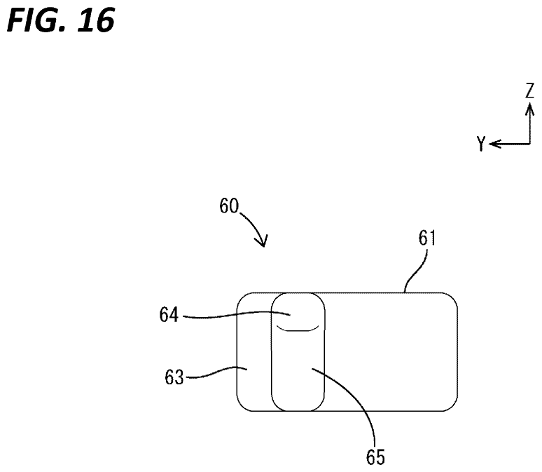

One specific embodiment of the present disclosure is described below with reference to FIGS. 1 to 16. Note that the present invention is not limited to these illustrations, but is represented by claims and intended to include all changes in the scope of claims and in the meaning and scope of equivalents. In this embodiment, a positive direction of an X axis in FIGS. 1 to 11 and 13 to 15 is defined as a forward direction concerning a front-rear direction. A positive direction of a Y axis in FIGS. 1 to 4 and 10 to 16 is defined as a rightward direction concerning a lateral direction. The lateral direction and a width direction are used as synonyms. A positive direction of a Z axis in FIGS. 1 to 9, 12, 14 and 16 is defined as an upward direction concerning a vertical direction.

A connector of the present disclosure is provided with one connector housing 10 and a plurality of female terminal fittings 50 as shown in FIGS. 1 to 3 and 5. The connector housing 10 is configured by assembling one housing body 11 and one terminal holding member 30.

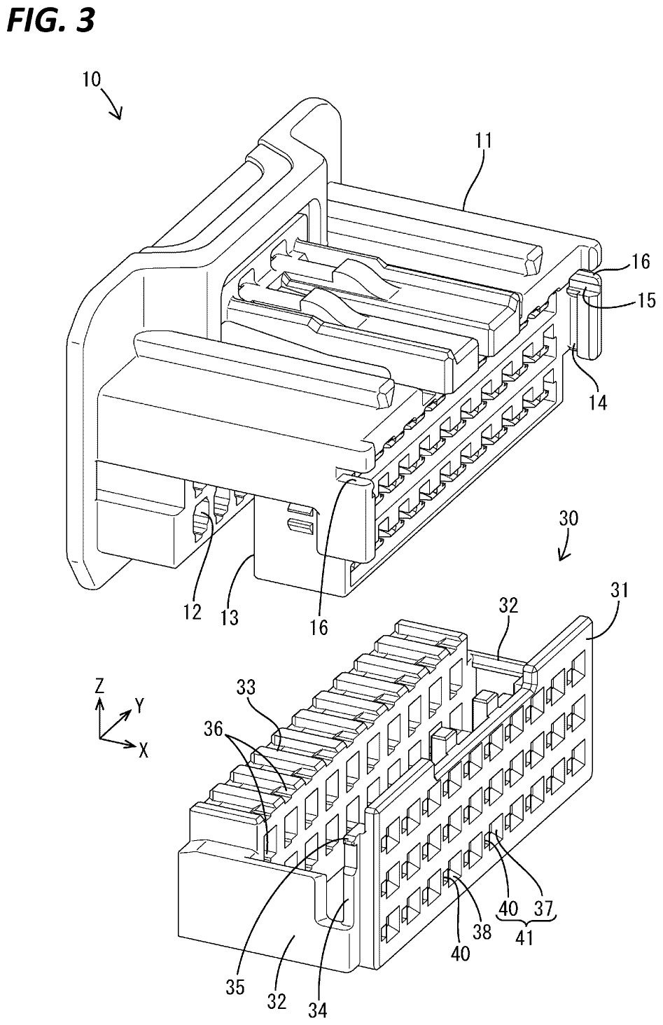

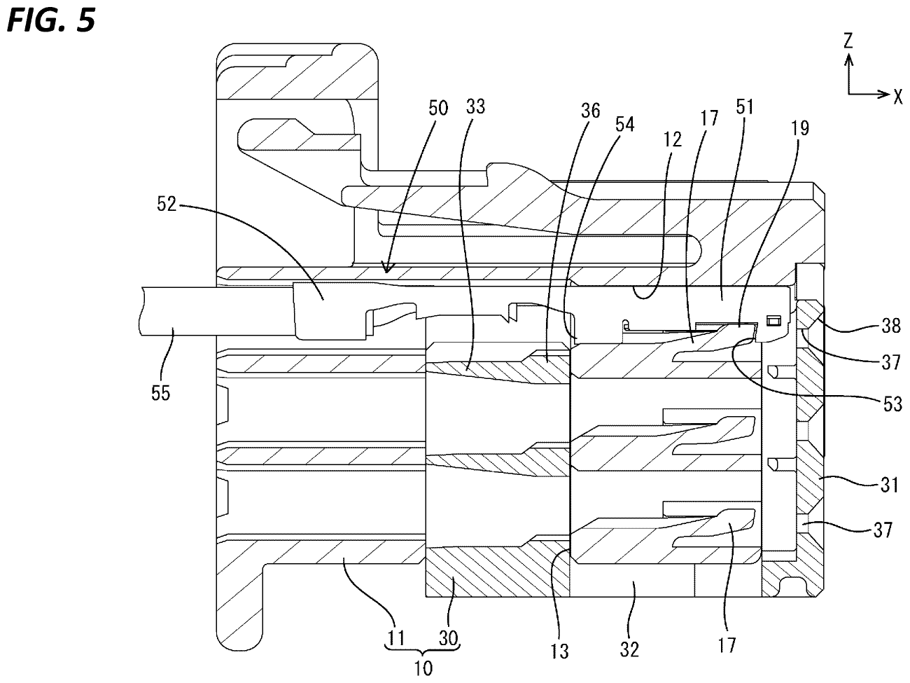

As shown in FIG. 5, a plurality of terminal accommodation chambers 12 are formed in the housing body 11. Each terminal accommodation chamber 12 is a space elongated in the front-rear direction and open in both front and rear surfaces of the housing body 11. The plurality of terminal accommodation chambers 12 are arranged side by side in the lateral direction (width direction). The housing body 11 is formed with an accommodation space 13 open in the lower surface of the housing body 11. The accommodation space 13 communicates with the plurality of terminal accommodation chambers 12. As shown in FIG. 3, a pair of guide grooves 14 are formed in both left and right side edge parts of the front surface of the housing body 11. A temporary lock holding portion 15 and a complete lock holding 16 are formed on an upper end part of the guide groove 14.

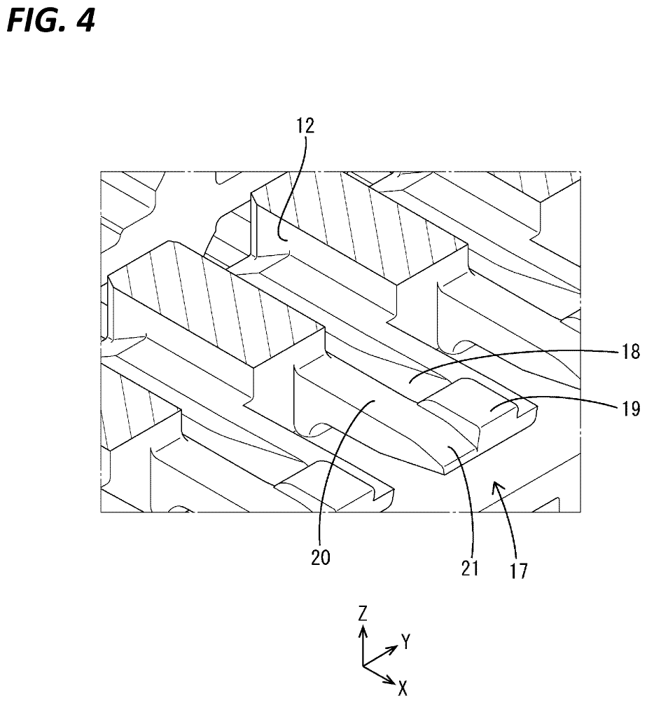

As shown in FIGS. 4 to 11, the terminal accommodation chamber 12 is formed with a locking lance 17. The locking lance 17 is cantilevered forward along a lower wall portion constituting the terminal accommodation chamber 12. The locking lance 17 is normally kept at a retaining position (retaining posture). The locking lance 17 is resiliently displaceable to a retention releasing position (retention releasing posture) with the rear end of the locking lance 17 as a fulcrum. With the locking lance 17 resiliently displaced to the retention releasing position, a front end part of the locking lance 17 is located below (direction away from the terminal accommodation chamber 12) the retaining position. A resilient deformation direction of the locking lance 17 is the vertical direction.

The locking lance 17 includes a lance body portion 18 and a primary locking portion 19. The lance body portion 18 is in the form of a plate having a plate thickness direction oriented in the vertical direction and extends forward from the lower wall portion. The primary locking portion 19 projects upward from the upper surface of a front end part of the lance body portion 18. The primary locking portion 19 is arranged in a lateral central part of the lance body portion 18. A part to the left of the primary locking portion 19, out of the lance body portion 18, functions as a jig contact portion 20. As shown in FIGS. 4, 6, 7 and 9, a guiding inclined surface 21 inclined to be gradually higher toward a rear side is formed on the upper surface of a front end part of the jig contact portion 20. The jig contact portion 20 including the guiding inclined surface 21 is a part for receiving a downward (retention releasing direction) pressing force from a jig 60.

As shown in FIGS. 3 and 5, the terminal holding member 30 includes a front wall portion 31, a pair of left and right side wall portions 32 and a retaining portion 33. In a front view of the terminal holding member 30, the front wall portion 31 has a rectangular shape as a whole. The pair of side wall portions 32 extend rearward from lower end parts of both left and right side edge parts of the front wall portion 31. The retaining portion 33 is arranged to connect rear end parts of the both left and right side wall portions 32 and has a rectangular shape as a whole. With the terminal holding member 30 assembled with the housing body 11, the front wall portion 31 is arranged to overlap the front surface of the housing body 11, the both left and right side wall portions 32 are arranged to overlap both left and right outer side surfaces of the housing body 11 and the retaining portion 33 is accommodated in the accommodation space 13.

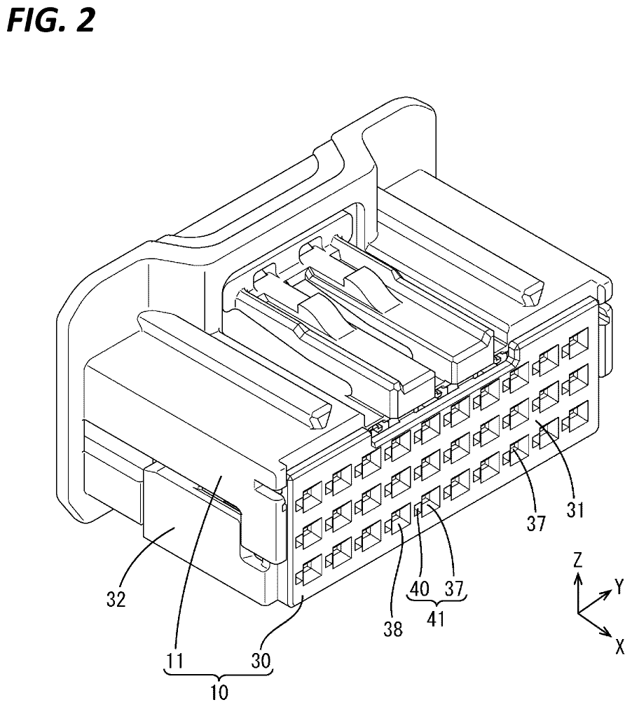

The terminal holding member 30 mounted in the housing body 11 is relatively movable between a temporary locking position (see FIGS. 2 and 5 to 7) and a complete locking position (see FIGS. 1, 8 and 9) above the temporary locking position with respect to the housing body 11. A moving direction between the temporary locking position and the complete locking position is a direction parallel to the front surface of the housing body 11 and the front wall portion 31. As shown in FIG. 3, a pair of guide ribs 34 extending in the vertical direction are formed on both left and right side edge parts of the front wall portion 31. A holding projection 35 is formed on an upper end part of the guide rib 34. By fitting the holding projections 35 to the temporary lock holding portions 15, the terminal holding member 30 is held at the temporary locking position. By fitting the holding projections 35 to the complete lock holding portions 16, the terminal holding member 30 is held at the complete locking position.

The retaining portion 33 includes a plurality of secondary locking portions 36 individually facing the respective terminal accommodation chambers 12. With the terminal holding member 30 located at the temporary locking position, the entire retaining portion 33 including the secondary locking portions 36 is located outside the terminal accommodation chambers 12. Therefore, in the process of inserting the female terminal fitting 50 to be described later into the terminal accommodation chamber 12, the female terminal fitting 50 does not interfere with the retaining portion 33 (secondary locking portion 36). With the terminal holding member 30 moved to the complete locking position, the secondary locking portions 36 of the retaining portion 33 are located in the terminal accommodation chambers 12 (insertion paths for the female terminal fittings 50).

The front wall portion 31 is a part having a function of preventing the female terminal fittings 50 inserted into the terminal accommodation chambers 12 from moving any further forward so as not to come out to a front surface side of the housing body 11. As shown in FIGS. 1 to 3, the front wall portion 31 is formed with a plurality of tab insertion holes 37 and a plurality of jig insertion holes 40. The tab insertion holes 37 and the jig insertion holes 40 are both shaped to penetrate through the front wall portion 31 in the front-rear direction. One tab insertion hole 37 and one jig insertion hole 40 located to the left of and adjacent to this tab insertion hole 37 constitute one inserting portion 41 corresponding to one terminal accommodation chamber 12.

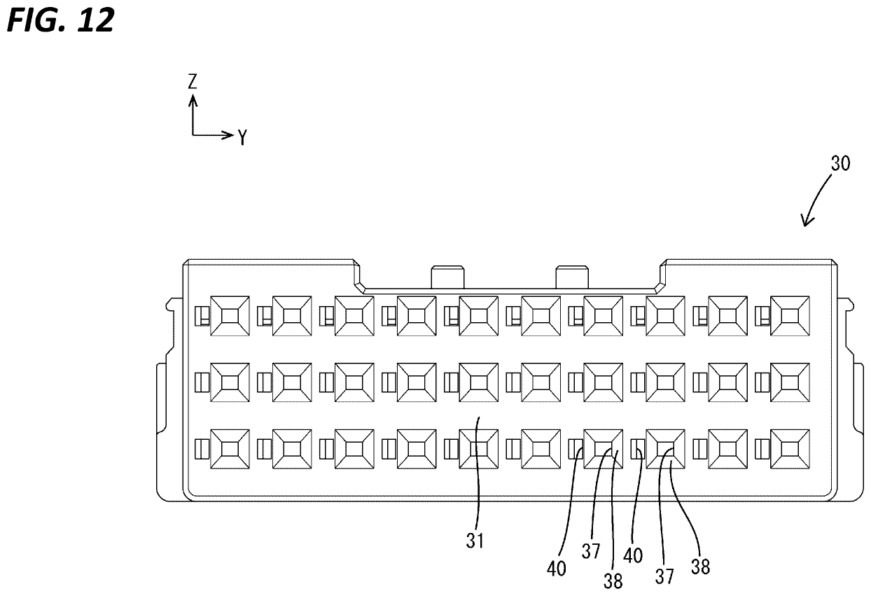

As shown in FIG. 12, the tab insertion hole 37 has a square opening shape having two sides in the vertical direction and two sides in the lateral direction in a front view. The tab insertion hole 37 is sized and shaped to position a tab 71 of a male terminal fitting 70 in the vertical direction and lateral direction. The front surface of the front wall portion 31 is formed with tapered guiding surfaces 38 individually surrounding the respective tab insertion holes 37. The guiding surface 38 is composed of four trapezoidal inclined surfaces. The four inclined surfaces are flat surfaces inclined to be gradually expanded from the front ends of four inner surfaces of the tab insertion hole 37 to the front end of the front wall portion 31.

In one inserting portion 41, the jig insertion hole 40 is arranged not to overlap the tab insertion hole 37 and the guiding surface 38. In other words, the jig insertion hole 40 is arranged at a position shifted further leftward than the left end of the guiding surface 38. The tab insertion hole 37 and the jig insertion hole 40 corresponding to one terminal accommodation chamber 12 have a common opening region in the vertical direction.

Even if the terminal holding member 30 moves between the temporary locking position and the complete locking position, the positions of the tab insertion holes 37 and the jig insertion holes 40 in the lateral direction remain unchanged. The tab insertion holes 37 are arranged to overlap formation regions of the terminal accommodation chambers 12 in the lateral direction. When the terminal holding member 30 is at the temporary locking position, the tab insertion holes 37 are deviated downward from the formation regions of the terminal accommodation chambers 12 and are arranged to overlap the locking lances 17 in the vertical direction. When the terminal holding member 30 is at the complete locking position, the tab insertion holes 37 are arranged to overlap the formation regions of the terminal accommodation chambers 12 in the vertical direction and be located above the entire locking lances 17 including the primary locking portions 19.

Regardless of whether the terminal holding member 30 is at the temporary locking position or the complete locking position, the jig insertion holes 40 are so arranged that the entire opening regions of the jig insertion holes 40 are deviated leftward from the formation regions of the accommodation chambers 12. When the terminal holding member 30 is at the temporary locking position, the jig insertion holes 40 are so arranged that the opening regions of the jig insertion holes 40 overlap formation regions of the jig contact portions 20, out of the locking lances 17, in the vertical direction. When the terminal holding member 30 is at the complete locking position, the jig insertion holes 40 are so arranged that the opening regions of the jig insertion holes 40 are deviated upward from the entire formation regions of the locking lances 17 including the jig contact portions 20.

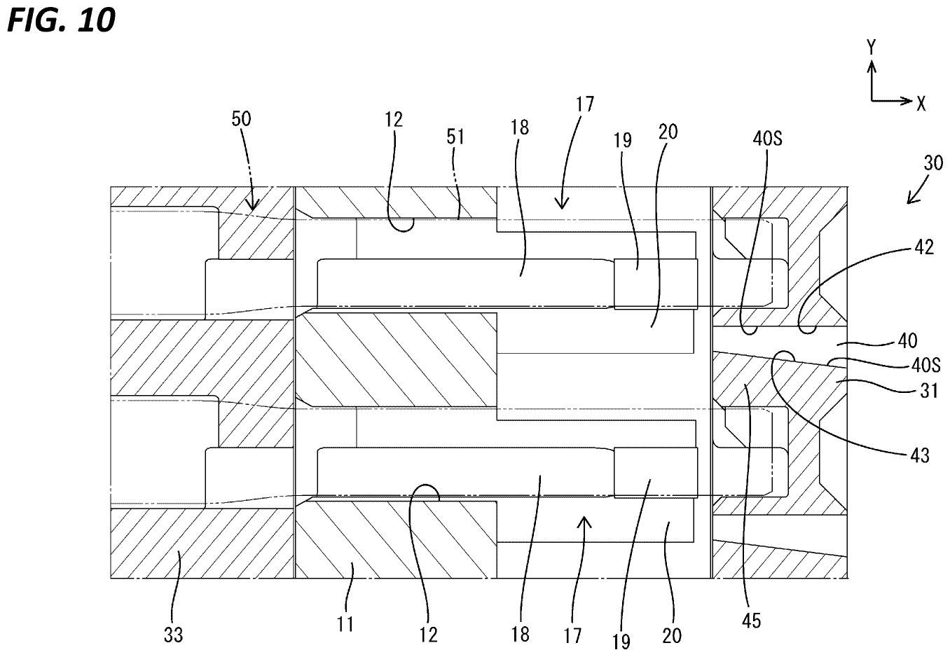

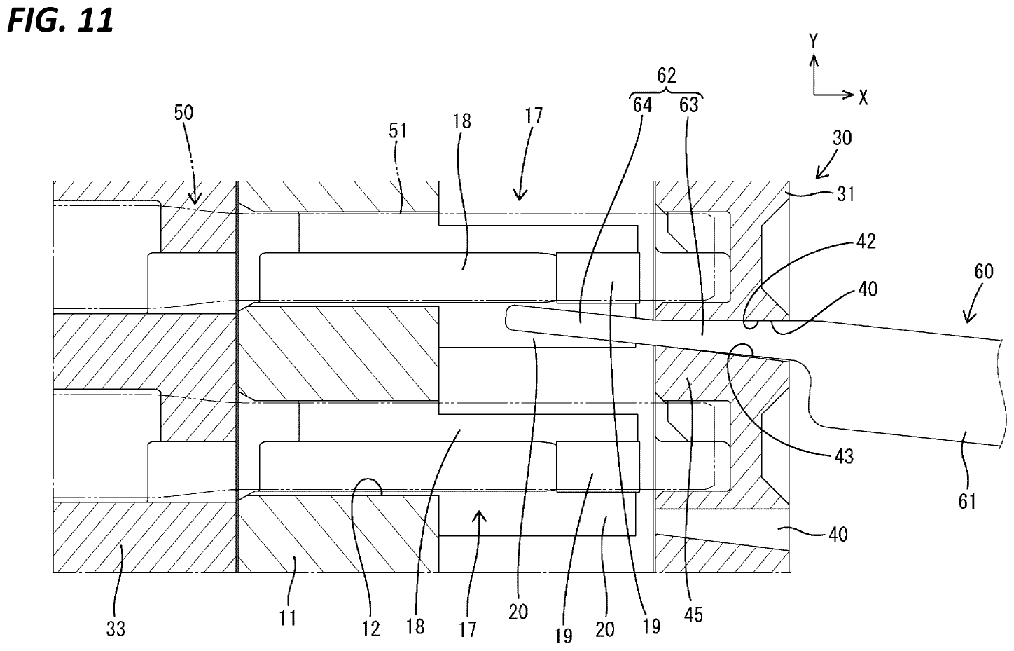

The jig insertion hole 40 has a vertically long rectangular opening shape having two sides in the vertical direction and two sides in the lateral direction in a front view. The heights of the upper and lower surfaces, out of the inner surfaces of the jig insertion hole 40, are constant over the entire jig insertion hole 40. As shown in FIGS. 10 and 11, a straight surface 42 is formed in the entire region of the right surface, out of the inner surfaces of the jig insertion hole 40. The straight surface 42 is a flat surface parallel to an insertion direction of the tab 71 into the tab insertion hole 37 (front-rear direction) and parallel to an extension direction of the locking lance 17 in a plan view of the terminal holding member 30. The entire straight surface 42 is located within a formation region range of the jig contact portion 20 in the lateral direction. In other words, the straight surface 42 is arranged to the left of the primary locking portion 19 of the locking lance 17 and to the right of the left end edge of the jig contact portion 20.

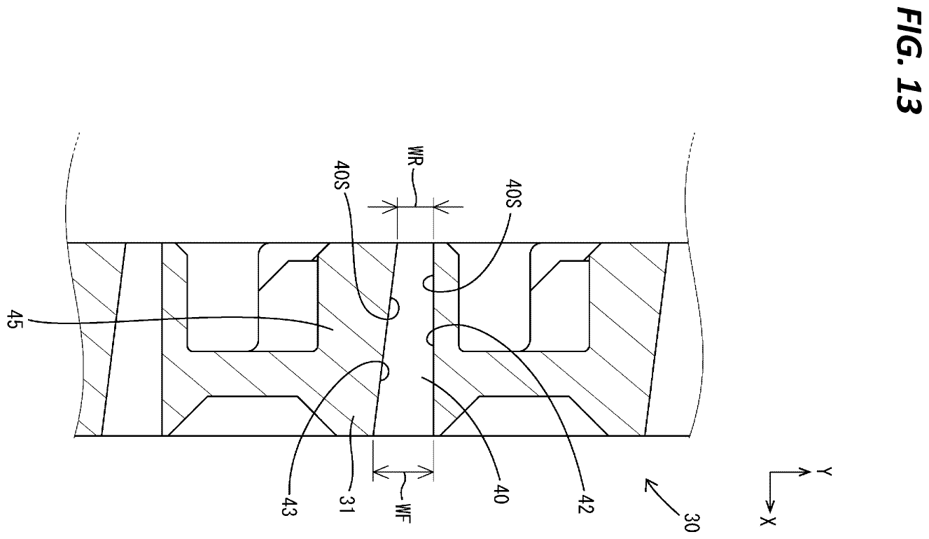

A guide surface 43 is formed in the entire region of the left surface, out of the inner surfaces of the jig insertion hole 40. As shown in FIGS. 10 and 11, the guide surface 43 is a flat surface inclined to the insertion direction of the tab 71 into the tab insertion hole 37 (front-rear direction) and the extension direction of the locking lance 17 in the plan view. The entire guide surface 43 is located to the left of the left edge of the jig contact portion 20. The front end of the guide surface 43 is located to the left of the rear end of the guide surface 43. An opening width in the lateral direction at the front end of the jig insertion hole 40 is larger than that at the rear end of the jig insertion hole 40. The guide surface 43 guides the jig 60 inserted into the jig insertion hole 40 from the front of the front wall portion 31 obliquely to a right rear side. As shown in FIG. 13, the plan view shape of the jig insertion hole 40 is a scalene trapezoid having an opening width WF at the front end (upper base) larger than an opening width WR at the rear end (lower base).

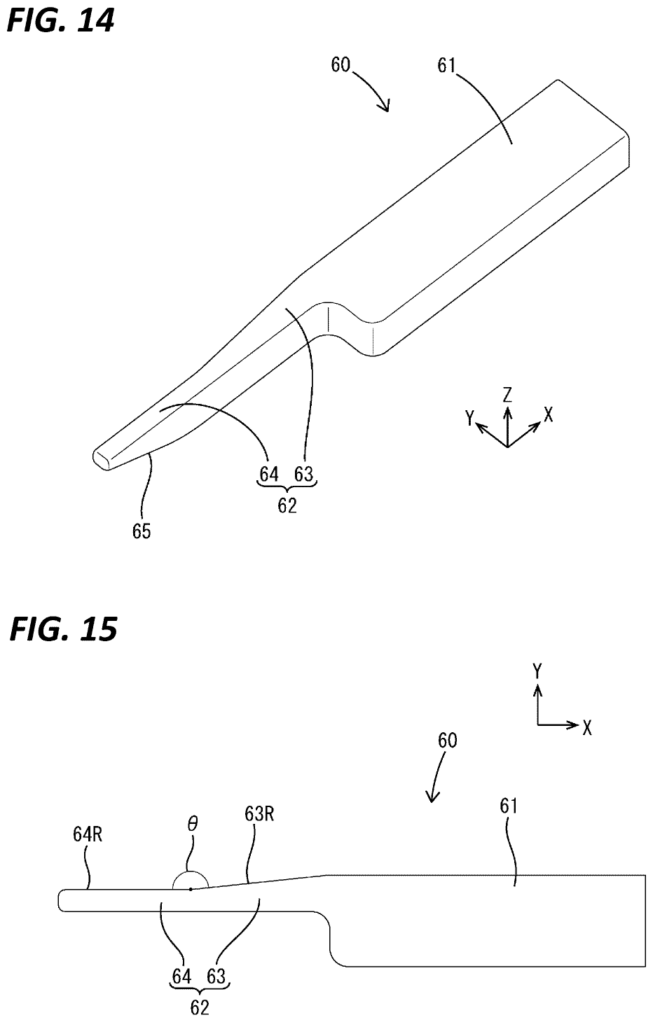

As shown in FIGS. 14 to 16, the jig 60 is a single component including a pinching portion 61 and an elongated releasing portion 62 projecting from the pinching portion 61. The releasing portion 62 includes a tapered portion 63 and a pressing portion 64. The tapered portion 63 is connected to the pinching portion 61 and projects rearward from the pinching portion 61. The tapered portion 63 has a trapezoidal plan view shape gradually narrowed in a projecting direction. The shape and size of the tapered portion 63 in the plan view are the same as the shape and size of the jig insertion hole 40 in the plan view. The pressing portion 64 is shaped to project further rearward from the projecting end of the tapered portion 63. As shown in FIG. 15, the pressing portion 64 has a plan view shape extending straight while having a constant width. The left side surface of the tapered portion 63 and that of the pressing portion 64 are continuous and flush to configure one elongated flat surface. A right side surface 63R of the tapered portion 63 and a right side surface 64R of the pressing portion 64 are connected at an obtuse angle θ (angle slightly smaller than 180°).

The upper surface of the releasing portion 62 is a flat surface at a constant height over the entire releasing portion 62. A pressing inclined surface 65 inclined to a length direction of the releasing portion 62 is formed on the lower surface of a front end part of the pressing portion 64. The pressing inclined surface 65 is inclined to be gradually higher from the side of the pinching portion 62 toward a tip side of the releasing portion 62. In other words, the pressing inclined surface 65 is inclined to gradually thin the pressing portion 64 from the side of the pinching portion 62 toward the tip side of the releasing portion 62. A thickness (height) of a region of the releasing portion 62 where the pressing inclined surface 65 is not formed is equal to or slightly smaller than a height of the jig insertion hole 40.

As shown in FIG. 2, the female terminal fitting 50 has a shape elongated in the front-rear direction as a whole. A front end part of the female terminal fitting 50 is formed with a rectangular tube portion 51 and a rear end part of the female terminal fitting 50 is formed with a crimping portion 52. The crimping portion 52 of the female terminal fitting 50 is conductively fixed to a front end part of a wire 55. A locking hole 53 for primary locking is formed in the lower surface of the rectangular tube portion 51. A rear end part of the rectangular tube portion 51 functions as a stepped locking portion 54 for secondary locking.

Next, functions and effects of this embodiment are described. In mounting the female terminal fittings 50 into the connector housing 10, the terminal holding member 30 is held at the temporary locking position. In this state, the female terminal fitting 50 is inserted into the terminal accommodation chamber 12 from behind the connector housing 10. In an insertion process, the rectangular tube portion 51 interferes with the primary locking portion 19, wherefore the locking lance 17 is resiliently deformed to the retention releasing position below. When the female terminal fitting 50 reaches a proper insertion position, the front end of the female terminal fitting 50 butts against the front wall portion 31, whereby the female terminal fitting 50 is prevented from moving any further forward. When the female terminal fitting 50 is inserted to the proper position, the locking lance 17 resiliently returns to the retaining position and the primary locking portion 19 is locked into the locking hole 53. By this locking action, the female terminal fitting 50 is retained and held with a rearward movement restricted. In the above way, the female terminal fitting 50 is primarily locked by the locking lance 17.

Thereafter, the terminal holding member 30 at the temporary locking position is moved to the complete locking position. If the terminal holding member 30 is moved to the complete locking position, the secondary locking portions 36 of the terminal holding member 30 enter the terminal accommodation chambers 12 and are locked to the stepped locking portions 54 of the female terminal fittings 50 from behind. By this locking action, the female terminal fittings 50 are secondarily locked to be reliably retained. With the terminal holding member 30 located at the complete locking position, the tab insertion holes 37 are located to be aligned with the rectangular tube portions 51 in the terminal accommodation chambers 12 in the front-rear direction at the same heights. In the above way, the mounting of the female terminal fittings 50 into the connector housing 10 is completed.

After the female terminal fittings 50 are mounted into the connector housing 10, the tab 71 of the male terminal fitting 70 is inserted into the tab insertion hole 37 from the front of the connector housing 10 and resiliently contacts a resilient contact piece (not shown) in the rectangular tube portion 51. The guiding surface 38 inclined to the insertion direction of the tab 71 is formed in front of the front end of the tab insertion hole 37. Even if the tab 71 is shifted in position in the vertical direction or lateral direction, the tab 71 is reliably guided to the tab insertion hole 37 by the guiding surface 38 and reliably connected to the female terminal fitting 50.

In removing the female terminal fitting 50 from the connector housing 10, the terminal holding member 30 is moved from the complete locking position to the temporary locking position. In this way, the secondary locking portions 36 of the retaining portion 33 are disengaged from the stepped locking portions 54 of the female terminal fittings 50, wherefore secondary locking by the terminal holding member 30 is released. If the terminal holding member 30 is moved to the temporary locking position, the jig insertion holes 40 are located at the same heights as the jig contact portions 20 of the locking lances 17. In this state, the releasing portion 62 of the jig 60 is inserted into the jig insertion hole 40 from the front of the front wall portion 31. The jig 60 is not relatively displaced in the vertical direction with respect to the jig insertion hole 40. As the jig 60 is further inserted and the pressing inclined surface 65 starts to slide in contact with the guiding inclined surface 21 of the locking lance 17, the locking lance 17 is pushed down from the retaining position to the retention releasing position by the inclination of the both inclined surfaces 21, 65.

In the process of inserting the jig 60, the jig 60 is possibly inclined or relatively displaced in the lateral direction with respect to the jig insertion hole 40. However, by sliding the left side surface of the releasing portion 62 in close contact with the guide surface 43, the position and orientation of the jig 60 in the lateral direction can be stabilized. The jig 60 guided by the guide surface 43 moves from an oblique left front side to an oblique right rear side of the locking lance 17. A moving direction of the jig 60 at this time is a direction oblique to the jig contact portion 20 elongated in the front-rear direction.

When substantially the entire tapered portion 63 is accommodated into the jig insertion hole 40, the jig 60 cannot be inserted any further. In the above way, the operation of the jig 60 is finished. At this time, since the locking lance 17 is displaced to the retention releasing position, the primary locking portion 19 of the locking lance 17 is separated downward from the locking hole 53 of the female terminal fitting 50 and primary locking by the locking lance 17 is released. Since the female terminal fitting 50 is enabled to be separated rearward in this way, the wire 55 may be pinched and the female terminal fitting 50 may be pulled out rearward from the terminal accommodation chamber 12 thereafter.

The connector of this embodiment is provided with the housing body 11 including the terminal accommodation chambers 12, the female terminal fittings 50 to be inserted into the terminal accommodation chambers 12 from behind the housing body 11 and the terminal holding member 30. The terminal holding member 30 is attached to the housing body 11 to cover the front surface of the housing body 11. The terminal holding member 30 holds the female terminal fittings 50 inserted into the terminal accommodation chambers 12 to prevent any further forward movements. The housing body 11 is formed with the locking lances 17. In the process of inserting the female terminal fitting 50, the locking lance 17 is resiliently deformed due to interference with the female terminal fitting 50. The locking lance 17 retains the female terminal fitting 50 inserted into the terminal accommodation chamber 12.

The terminal holding member 30 is formed with the tab insertion holes 37 and the jig insertion holes 40. The tab 71 of the male terminal fitting 70 is inserted into the tab insertion hole 37 from the front of the terminal holding member 30. The jig 60 for disengaging the locking lance 17 from the female terminal fitting 50 is inserted into the jig insertion hole 40. The terminal holding member 30 is formed with the guiding surfaces 38 arranged to surround the tab insertion holes 37 in a front view. The guiding surface 38 guides the tab 71 into the tab insertion hole 37. The tab insertion hole 37 and the jig insertion hole 40 are arranged side by side in the width direction intersecting the resilient deformation direction of the locking lance 17.

According to this configuration, even if the jig insertion hole 40 is not arranged to overlap the guiding surface 38, a size reduction is possible in the resilient deformation direction (vertical direction) of the locking lance 17. Since the opening region of the jig insertion hole 40 does not overlap the guiding surface 38, the guiding surface 38 is not cut by the jig insertion hole 40. Thus, according to the connector of this embodiment, a size reduction is possible in the resilient deformation direction of the locking lances 17 while erroneous insertion of the tabs 71 into the jig insertion holes 40 is prevented.

The terminal holding member 30 includes the retaining portion 33 for preventing rearward movements of the female terminal fittings 50 in the terminal accommodation chambers 12. According to this configuration, the number of components can be reduced as compared to the case where a dedicated member for retaining the female terminal fittings 50 is provided separately from the terminal holding member 30.

The locking lance 17 is formed with the jig contact portion 20 to be contacted by the jig 60. The terminal holding member 30 is movable between the temporary locking position where the insertion of the female terminal fittings 50 is allowed and the complete locking position where the female terminal fittings 50 are retained. When the terminal holding member 30 is at the complete locking position, the jig insertion holes 40 are arranged at positions separated upward from the jig contact portions 20 in a front view of the terminal holding member 30. According to this configuration, with the terminal holding member 30 located at the complete locking position, erroneous deflection of the locking lance 17 can be prevented even if the jig 60 is inserted into the jig insertion hole 40.

In the width direction, the jig contact portion 20 is arranged in a region to the left of (outward of) the left outer side surface of the female terminal fitting 50. According to this configuration, when the jig 60 contacts the jig contact portion 20, the interference of the jig 60 and the female terminal fitting 50 can be prevented.

The jig insertion hole 40 is formed with the guide surface 43. In a plan view of the terminal holding member 30 when viewed in the same direction as the resilient deformation direction of the locking lance 17, the guide surface 43 is inclined to the insertion direction of the tab 71 into the tab insertion hole 37. According to this configuration, the jig 60 can be obliquely brought into contact with the jig contact portion 20 by inserting the jig 60 along the guide surface 43 into the jig insertion hole 40. Therefore, even if the jig 60 and the jig contact portion 20 have a narrow shape, the jig 60 can be reliably brought into contact with the jig contact portion 20.

As shown in FIGS. 10 and 13, the guide surface 43 is formed only on an inner side surface 40S on a left side distant from the tab insertion hole 37, out of a pair of left and right inner side surfaces 40S facing each other in the width direction in the jig insertion hole 40. The both left and right inner side surfaces 40S are parts of the inner surfaces of the jig insertion hole 40. According to this configuration, it is possible to ensure a large thickness of a separation wall 45 between the jig insertion hole 40 for one terminal accommodation chamber 12, out of the terminal accommodation chambers 12 adjacent in the width direction, and the tab insertion hole 37 for the other terminal accommodation chamber 12 (see FIGS. 10, 11 and 13).

The jig insertion hole 40 is formed with the straight surface 42. The straight surface 42 is facing the guide surface 43 in the width direction and parallel to the insertion direction of the tab 71 into the tab insertion hole 37. According to this configuration, the jig insertion holes 40 (terminal holding member 30) can be molded by a mold, which is opened in parallel to the insertion direction of the tabs 71 into the tab insertion holes 37.

The front end of the guide surface 43 is located outward of (to the left of) the left outer side surface of the locking lance 17 in the width direction. According to this configuration, since a large angle of inclination of the guide surface 43 to the insertion direction of the tab 71 into the tab insertion hole 37 is ensured, the jig 60 can be more reliably brought into contact with the jig contact portion 20.

An opening dimension in the width direction at the rear end of the jig insertion hole 40 is larger than that at the front end of the jig insertion hole 40. According to this configuration, the jig 60 can be prevented from moving any further forward by a difference between the opening dimensions in the width direction at the front end and the rear end of the jig insertion hole 40.

### Other Embodiments

The present invention is not limited to the above described and illustrated embodiment, but is represented by claims. The present invention includes all changes in the scope of claims and in the meaning and scope of equivalents and also includes the following embodiments.

The terminal holding member may be a component not including the retaining portion.

When the terminal holding member is at the complete locking position, the jig insertion holes may be arranged at positions where the jig contact portions can be visually confirmed in a front view.

The guide surface may be formed on the inner side surface near the tab insertion hole, out of the pair of inner side surfaces of the jig insertion hole facing each other in the width direction.

The jig insertion hole may be shaped not to have the guide surface.

The jig insertion hole may be shaped not to have the straight surface.

### LIST OF REFERENCE NUMERALS

10 . . . connector housing
11 . . . housing body
12 . . . terminal accommodation chamber
13 . . . accommodation space
14 . . . guide groove
15 . . . temporary lock holding portion
16 . . . complete lock holding portion
17 . . . locking lance
18 . . . lance body portion
19 . . . primary locking portion
20 . . . jig contact portion
21 . . . guiding inclined surface
30 . . . terminal holding member
31 . . . front wall portion
32 . . . side wall portion
33 . . . retaining portion
34 guide rib
35 . . . holding projection
36 . . . secondary locking portion
37 . . . tab insertion hole
38 . . . guiding surface
40 . . . jig insertion hole
40S . . . inner side surface of jig insertion hole
41 . . . inserting portion
42 . . . straight surface
43 . . . guide surface
45 . . . separation wall portion
50 . . . female terminal fitting
51 . . . rectangular tube portion
52 . . . crimping portion
53 . . . locking hole
54 . . . stepped locking portion
55 . . . wire
60 . . . jig
61 . . . pinching portion
62 . . . releasing portion
63 . . . tapered portion
64 . . . pressing portion
65 . . . pressing inclined surface
70 . . . male terminal fitting
71 . . . tab

1. A connector, comprising:
a housing body including a terminal accommodation chamber;
a female terminal fitting to be inserted into the terminal accommodation chamber from behind the housing body; and
a terminal holding member to be attached to the housing body to cover a front surface of the housing body, the terminal holding member holding the female terminal fitting in the terminal accommodation chamber to prevent any further forward movement,
the housing body being formed with a locking lance to be resiliently deformed due to interference with the female terminal fitting in an insertion process of the female terminal fitting, the locking lance retaining the female terminal fitting inserted into the terminal accommodation chamber,
the terminal holding member being formed with:
a jig insertion hole, a jig for disengaging the locking lance from the female terminal fitting being inserted into the jig insertion hole;
a tab insertion hole, a tab of a male terminal fitting being inserted into the tab insertion hole from front of the terminal holding member; and
a guiding surface for guiding the tab into the tab insertion hole, and
the tab insertion hole and the jig insertion hole being arranged side by side in a width direction intersecting a resilient deformation direction of the locking lance.

2. The connector of claim 1, wherein the terminal holding member includes a retaining portion for preventing a rearward movement of the female terminal fitting in the terminal accommodation chamber.

3. The connector of claim 1, wherein:
the locking lance is formed with a jig contact portion to be contacted by the jig,
the terminal holding member is movable between a temporary locking position where insertion of the female terminal fitting is allowed and a complete locking position where the female terminal fitting is retained, and
the jig insertion hole is arranged at a position separated from the jig contact portion in a front view of the terminal holding member when the terminal holding member is at the complete locking position.

4. The connector of claim 1, wherein:
the locking lance is formed with a jig contact portion to be contacted by the jig, and
the jig contact portion is arranged in a region outward of an outer side surface of the female terminal fitting in the width direction.

5. The connector of claim 1, wherein:
the locking lance is formed with a jig contact portion to be contacted by the jig,
the jig insertion hole is formed with a guide surface, and
the guide surface is inclined to an insertion direction of the tab into the tab insertion hole in a plan view of the terminal holding member when viewed in the same direction as the resilient deformation direction of the locking lance.

6. The connector of claim 5, wherein the guide surface is formed on an inner side surface distant from the tab insertion hole, out of a pair of inner side surfaces facing each other in the width direction, in the jig insertion hole.

7. The connector of claim 5, wherein the jig insertion hole is formed with a straight surface facing the guide surface in the width direction and parallel to the insertion direction of the tab into the tab insertion hole.

8. The connector of claim 5, wherein a front end of the guide surface is located outward of an outer side edge of the locking lance in the width direction.

9. The connector of claim 1, wherein an opening dimension in the width direction at a rear end of the jig insertion hole is smaller than that at a front end of the jig insertion hole.
